(19) United States
(12) Patent Application Publication
(10) Pub. No.: US 2016/0381456 A1
(43) Pub. Date: Dec. 29, 2016

(54) MICROPHONE WITH INTERNAL PARAMETER CALIBRATION

(71) Applicant: ROBERT BOSCH GMBH, Stuttgart (DE)

(72) Inventor: Andrew J. Doller, Sharpsburg, PA (US)

(21) Appl. No.: 14/902,398

(22) PCT Filed: Jun. 27, 2014
(86) PCT No.: PCT/US2014/044509

§ 371 Date: Dec. 31, 2015

Related U.S. Application Data
(63) Continuation of application No. 14/258,465, filed on Apr. 22, 2014, now Pat. No. 9,414,175.
(60) Provisional application No. 61/842,694, filed on Jul. 3, 2013.

(51) Int. Cl. H04R 3/00; H04R 1/04; H04R 19/04

(52) U.S. Cl. CPC H04R 3/005; H04R 19/04; H04R 1/04; H04R 2201/003

(57) ABSTRACT

In one embodiment, the invention is a microphone system for adjusting the final output sensitivity of a microphone. The system includes transducers that output transducer signals. The system also includes bias circuits providing bias signals to the transducers, as well as amplifiers to receive the transducer signals and output amplified signals. The amplified signals are summed by a summer, which outputs a summed signal. A controller receives the summed signal, and is configured to obtain a desired microphone output characteristic and calculate adjustment amounts based on the characteristic. The controller modifies signals from the transducers based on the adjustment amounts. The controller then outputs a microphone signal based on the summed signal. In another embodiment, the invention provides a method for adjusting the final output sensitivity of a microphone.

### RELATED APPLICATIONS

The present application claims the benefit of prior filed co-pending U.S. Provisional Patent Application No. 61/842694, filed on Jul. 3, 2013, and prior filed co-pending U.S. patent application Ser. No. 14/258,465, filed Apr. 22, 2014 (attorney docket no. 081276-9719), the entire content of each is hereby incorporated by reference.

### BACKGROUND

The present invention relates to a microphone, specifically to a microphone with an internal parameter calibration and communication system.

In order to take detailed measurements with a microphone, its absolute sensitivity must be known. Since this may change over the lifetime of the device, it is necessary to regularly calibrate measurement microphones. A microphone's output sensitivity varies with frequency (as well as with other factors such as environmental conditions) and is therefore normally recorded as several sensitivity values, each for a specific frequency band. A microphone's output sensitivity can also depend on the nature of the sound field it is exposed to. For this reason, microphones are often calibrated in more than one sound field, for example a pressure field and a free field.

Microphone calibration services are offered by some microphone manufacturers and by independent certified testing labs. The calibration techniques carried out at designated microphone calibration sites often involve multiple additional microphones in order to calibrate a single device. All microphone calibration is ultimately traceable to primary standards at a National Measurement Institute, such as NIST in the U.S. The reciprocity calibration technique is the recognized international standard with regard to microphone calibration and testing procedures.

### SUMMARY

The final output sensitivity of a microphone signal can be controlled by either applying a calculated electronic gain to an input signal (generated by the transducers upon receiving acoustic pressure waves from an acoustic source) or by modulating a bias voltage applied to a MEMS transducer. The final output sensitivity of the microphone signal can be controlled based on user-defined adjustment parameters.

In one embodiment, the invention is a microphone system for adjusting the final output sensitivity of a microphone signal. The system includes a first transducer outputting a first transducer signal and a second transducer outputting a second transducer signal. The system also includes a first and second bias circuit providing a first and second bias signal to the first and second transducers, respectively. A first amplifier receives the first transducer signal and outputs a first amplified transducer signal, and a second amplifier receives the second transducer signal and outputs a second amplified transducer signal. The first and second amplified transducer signals are then summed by a summer, which outputs a summed signal. A controller receives the summed signal. The controller is configured to obtain a desired microphone output characteristic and calculated a first and a second adjustment amount based on the desired microphone output characteristic. The controller is also configured to modify a signal from the first transducer based on the first calculated adjustment amount, and modify a signal from the second transducer based on the second calculated adjustment amount. The controller then outputs a microphone signal based on the summed signal.

In another embodiment, the invention provides a method for operating a microphone such that the final output sensitivity of the microphone signal can be adjusted. The method includes outputting a first transducer signal by a first transducer, and outputting a second transducer signal by a second transducer. The method also includes providing the first transducer with a first bias signal and providing the second transducer with a second bias signal. Further, the method includes receiving the first and second transducer signals by a first and second amplifier, where the first amplifier then outputs a first amplified transducer signal and the second amplifier outputs a second amplified transducer signal. A summer then receives the first and second transducer signals and outputs a summed signal to a controller. The controller is involved in obtaining a desired microphone output Characteristic and calculating a first and a second adjustment amount based on the desired microphone output characteristic. The controller is also involved in modifying a signal from the first transducer based on the first calculated adjustment amount, and modifying a signal from the second transducer based on the second calculated adjustment amount. The controller then outputs a microphone signal based on the summed signal.

Other aspects of the invention will become apparent by consideration of the detailed description and accompanying drawings.

### BRIEF DESCRIPTION OF THE DRAWINGS

FIG. 1 is a schematic of a microphone that uses electronic gain to control an output signal.

FIG. 2 is a schematic of a microphone that uses a controllable MEMS bias to control an output signal.

FIG. 3 is a schematic of another microphone embodiment that uses electronic gain to control an output signal.

FIG. 4 is a schematic of a microphone that uses a controllable MEMS bias and a three-electrode MEMS device to control an output signal.

FIG. 5 is a schematic of a microphone embodiment that uses a controllable MEMS bias and two three-electrode MEMS devices to control an output signal.

FIG. 6 illustrates the measurements taken to calibrate a microphone.

FIG. 7A is a test setup for performing measurements 1 and 2 in FIG. 6.

FIG. 7B is a test setup for performing measurements 3 and 4 in FIG. 6.

FIG. 8 illustrates two variations of a split electrode MEMS transducer.

FIGS. 9A-9F illustrate additional exemplary test setups.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

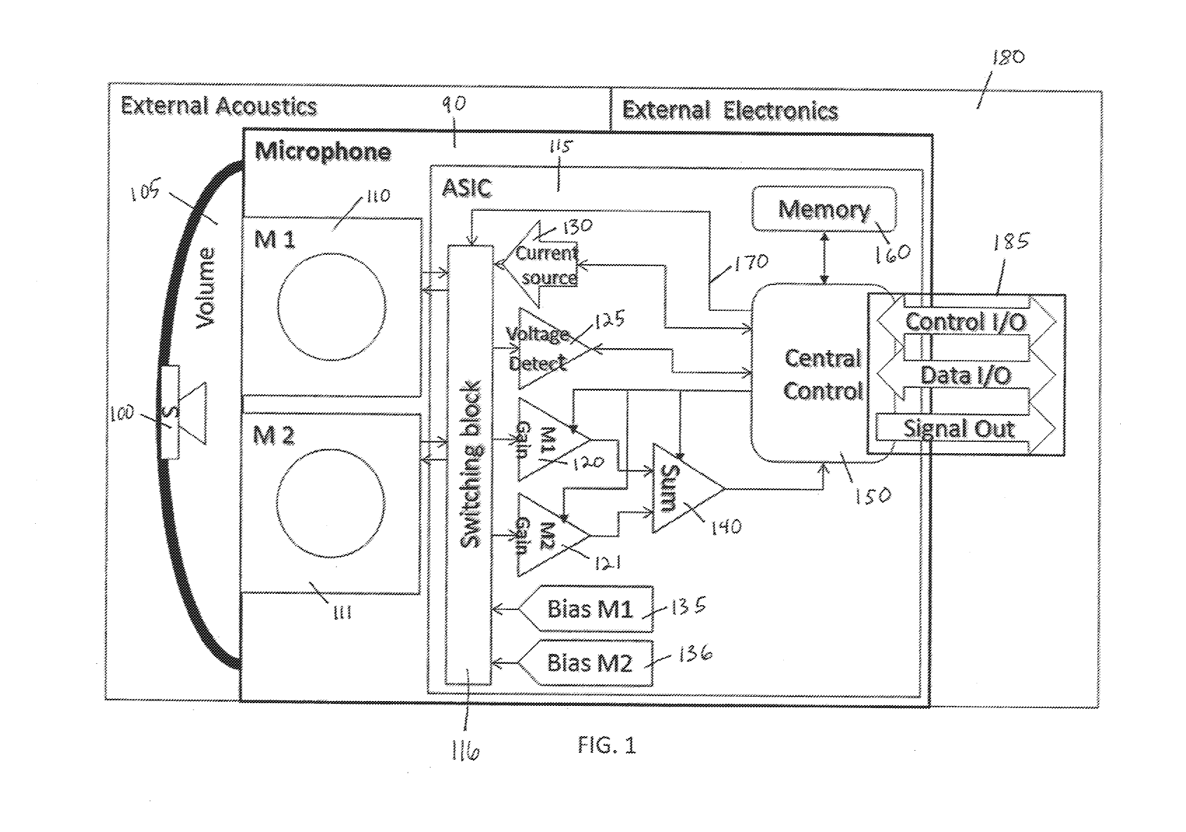

FIG. 1 is a microphone 90 that adjusts the output sensitivity of a microphone signal by controlling an electronic gain applied to the input signal (i.e., the signal generated by the transducers in response to receiving acoustic pressure waves from an acoustic pressure source). The microphone includes a speaker 100 placed within an acoustic volume 105 that is filled with a fluid such as air. The microphone also includes a first pressure-sensitive membrane 110 and a second pressure-sensitive membrane 111, and includes an application-specific integrated circuit (ASIC) 115. The membranes 110 and 111 are connected to the ASIC 115 through a switching block 116 included in the ASIC 115. The switching block 116 is connected to a first amplifier 120 and a second amplifier 121, a voltage detector 125, a current source 130, and a first and second bias circuit 135 and 136 by which bias voltages are applied to the membranes 110 and 111. The amplifiers 120 and 121 are further connected to a summing amplifier 140, which in turn connects to a controller 150. The controller 150 is also connected to a memory 160 (e.g., a non-transitory computer readable media).

The controller 150 can comprise a processor for executing code from the memory 160. The controller 150 also sends commands and/or data to the components included in the ASIC via a communication bus 170, except to the bias supply means 135 and 136. Also, the controller 150 sends commands and communicates with the external electronics via an input/output interface 185. The controller 150 also receives input from the components in the ASIC via the communication bus 170, and receives input from the external electronics 180 via the input/output interface 185. The input/output interface 185 can include a user interface such as a Liquid Crystal Display (LCD) screen or software Graphical User Interface (GUI), for example. The controller 150 can communicate parameters with a user through the input/output interface 185, and a user can input parameters to the controller 150 through the input/output interface 185.

The final output sensitivity of a microphone refers to the final sensitivity of the microphone's output signal, which can be adjusted by the internal microphone electronics. For example, in FIG. 1, the controller 150 modulates the gains of the amplifiers 120 and 121 to modify the output sensitivity of the microphone 90. When the first and second membranes 110 and 111 receive acoustic pressure inputs from the speaker 100 (propagating through the acoustic volume 105), a first and second electrical signal is generated by the membranes 110 and 111, respectively, in response. The signals generated by the membranes 110 and 111 are received by the switching block 116 based on the characteristics (such as frequency) of the pressure input, and the switching block 116 outputs the signals to the first and second amplifiers 120 and 121. The first amplifier 120 applies a gain to the first transducer's 110 generated signal, and the second amplifier 121 applies a gain to the second transducer's 111 generated signal. The modified signals are then summed at the summing amplifier 140 and sent to the controller 150. The controller 150 then outputs the summed modified acoustic signal (which now exhibits the adjusted output sensitivity) via the input output interface 185. Alternatively or additionally, the controller 150 stores the signal to the memory 160 (e.g., to be recalled for future microphone operations).

The gains applied to each signal by the amplifiers 120 and 121 are calculated by the controller 150 based on information received via the input/output interface 185. This adjustment information received via the input/output interface 185 can either be user-specified or determined otherwise by the external electronics 180. The adjustment information can include a user-specified voltage, and can be stored to the memory 160 for future communication with the user or the external electronics 180 (such as at a subsequent power on, for example). Similarly, the absolute sensitivity of the membranes 110 and 111 (as determined at manufacture), as well as the final output sensitivity of the microphone 90 (generated based on the adjustment input information), can also be stored to the memory 160 for future communication or processing.

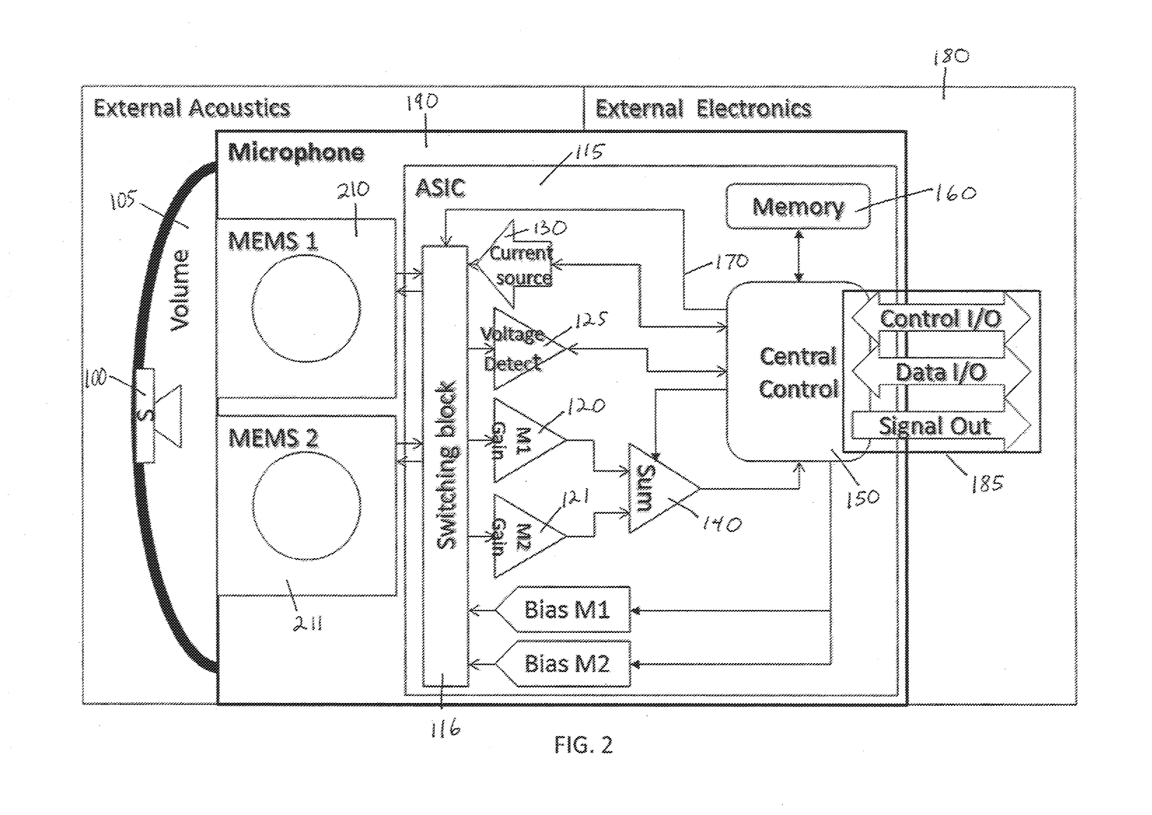

FIG. 2 illustrates a microphone 190 that controls the final output sensitivity by varying MEMS biasing. It should be noted that the microphone 190 of FIG. 2 includes many of the same components as those described in FIG. 1. Therefore, these components are numbered according to the reference numerals of FIG. 1. This is done for ease of description of the exemplary embodiments only, and is not intended to imply that like components must be implemented in other embodiments of the invention. In FIG. 2, first and second MEMS transducers 210 and 211 receive acoustic pressure waves from the speaker 100, as opposed to the pressure-sensitive membranes 110 and 111 of FIG. 1. In the case of FIG. 2, the signals generated by the MEMS transducers 210 and 211 are modified by adjusting the bias voltages applied to the MEMS transducers 210 and 211 by bias elements 135 and 136 through the switching block 116. Particularly, the controller 150 calculates the amount of bias voltage to apply to the MEMS transducers 210 and 211. By modulating the amount of bias voltage applied to the MEMS transducers 210 and 211, a transduction coefficient of the MEMS transducers 210 and 211 can be changed. Changing the transduction coefficient adjusts the transducer sensitivity and thus the sensitivity of the output signal. The calculated bias voltages are applied at the switching block 116 such that the bias voltage from bias element 135 is applied to the MEMS transducer 210, and the bias voltage from bias element 136 is applied to the MEMS transducer 211.

The switching block 116 then outputs the modified signals to the amplifiers 120 and 121, and the summing amplifier 140 further sums the signals. Note that in the case of FIG. 2, the amplifiers 120 and 121 are not controlled by the controller 150. However, the controller 150 still controls the summing amplifier 140. After the modified signals are summed at the summing amplifier 140, the summed modified signal is received by the controller 150 to be output via the input/output interface 185 or to be stored to the memory 160. As explained above with regard to FIG. 1, the controller 150 determines the amount of bias for each signal based on the specified adjustment information (i.e., data) received via the input/output interface 185. As with the microphone 90 in FIG. 1, the absolute sensitivity of the MEMS transducers, as well as the final output sensitivity of the acoustic signal can be stored to the memory 160 for future recall.

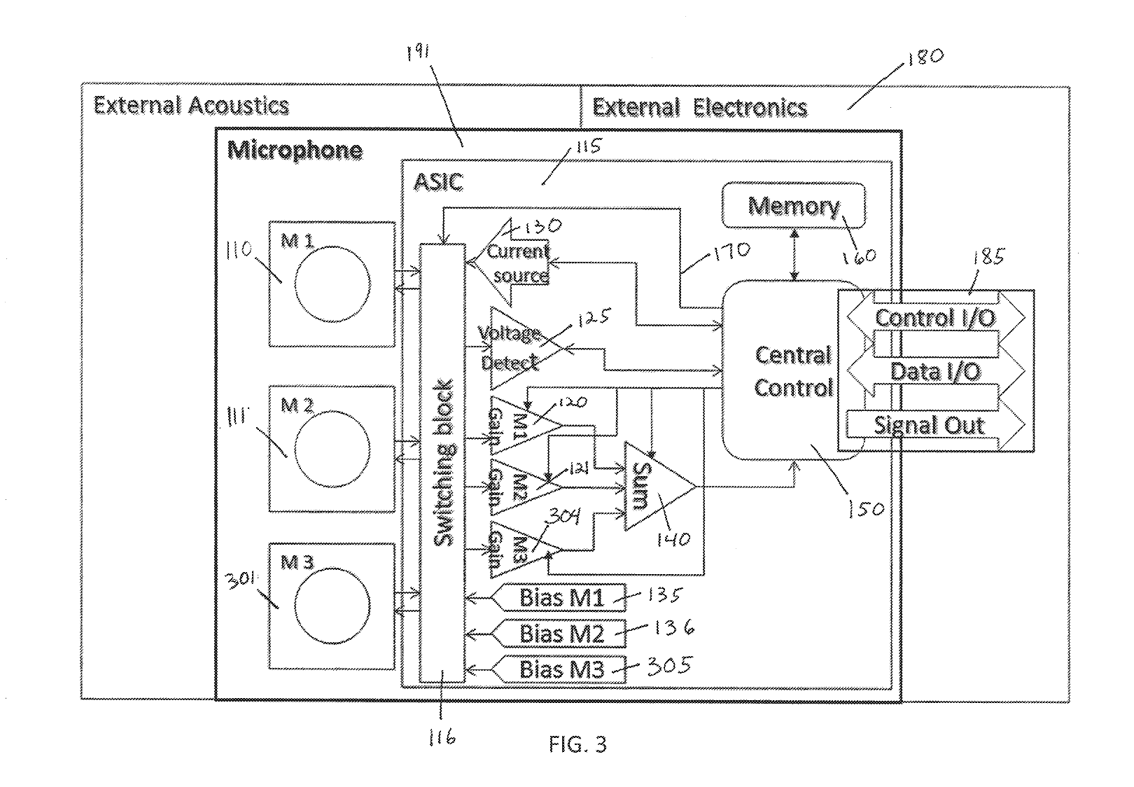

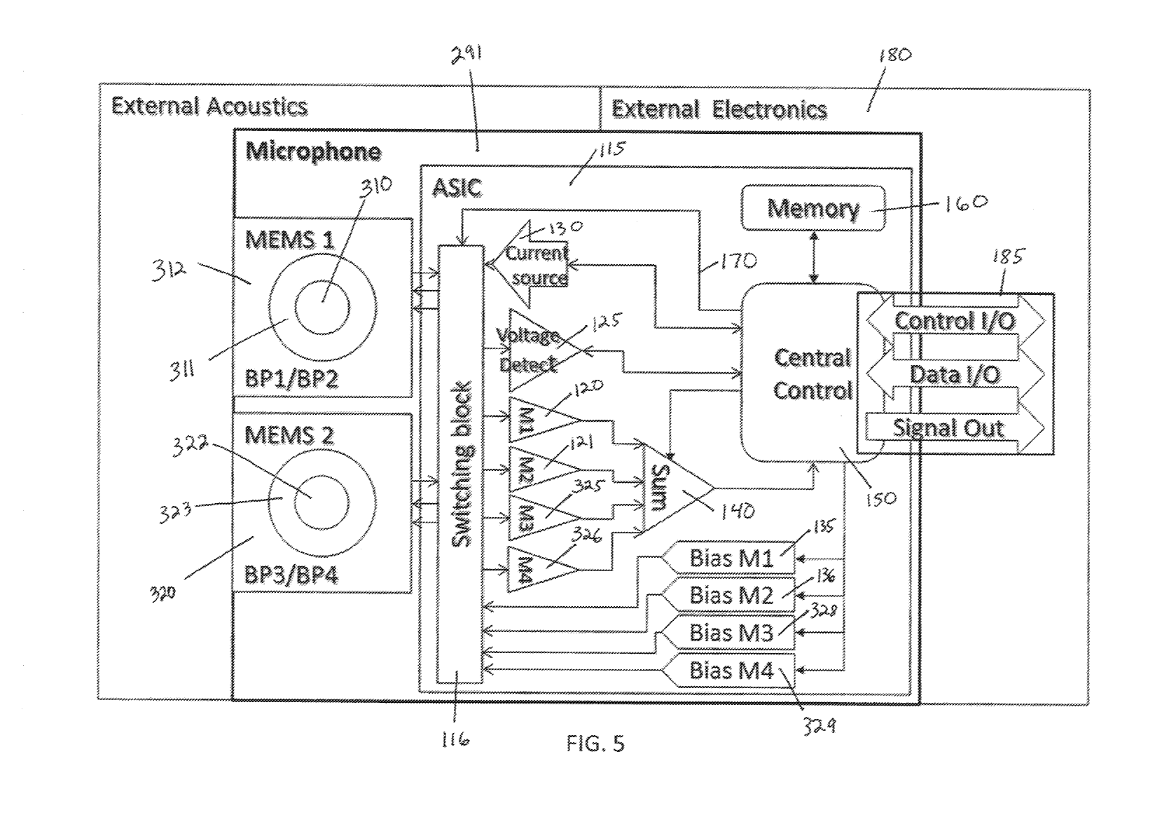

FIG. 3 illustrates a microphone similar to that of FIG. 1. However, the microphone of FIG. 5 includes a third pressure-sensitive membrane 301. The microphone of FIG. 3 also includes a third amplifier 304 that receives signals generated by the third membrane 301. As with the amplifiers 120 and 121, the third amplifier 304 is controlled by the controller 150 via the bus 170. Thus, the controller 150 can modify the gain of the third amplifier 304, which modifies the output sensitivity of the third membrane 301. The output of the third amplifier 304 is also summed at the summer 140 with the outputs from the amplifiers 120 and 121. Further, a third bias element 305 provides a bias voltage to the membrane 301.

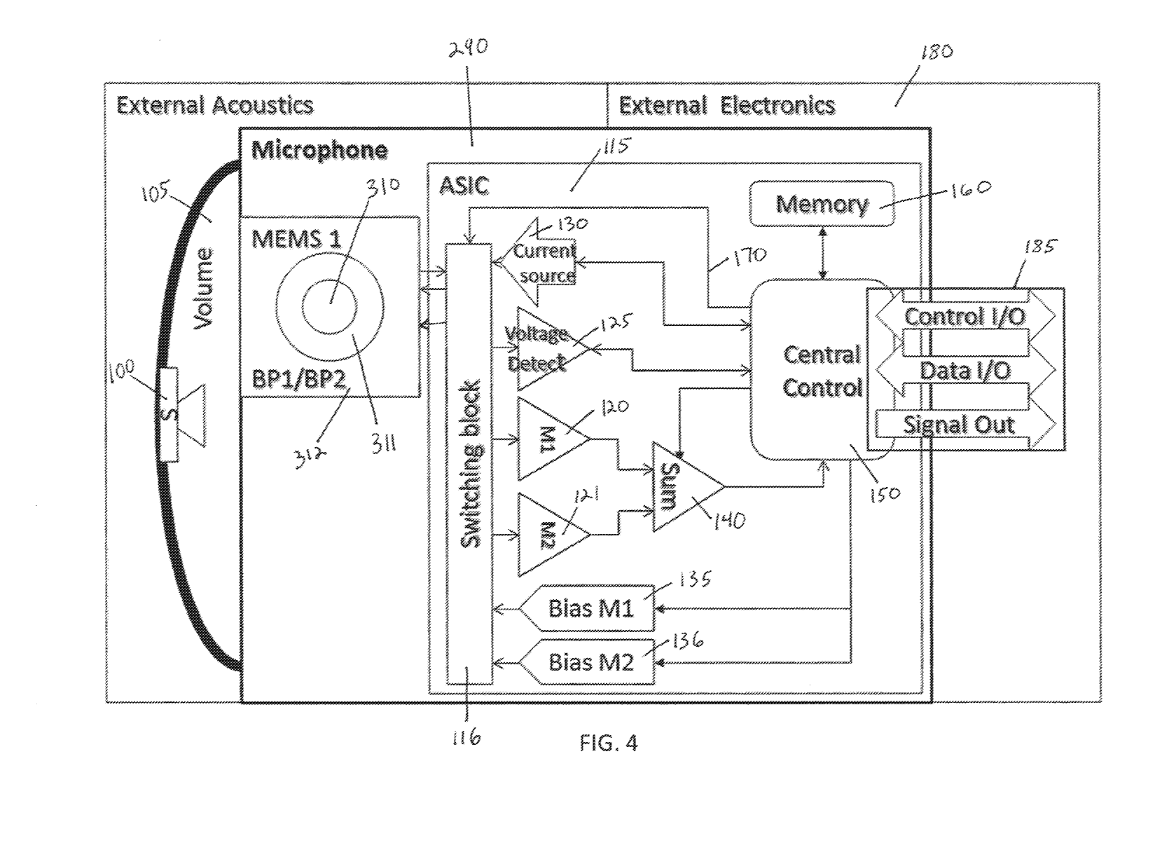

FIG. 4 shows a microphone similar to that of FIG. 2. The microphone of FIG. 4, however, uses split electrodes 310 and 311 contained on a single die of MEMS transducer 312, rather than the two electrodes on two separate dies of FIG. 2. The backplates (“BP1/BP2”) of the MEMS transducer 312 are electrically isolated from one another to accommodate for the split arrangement of electrodes 310 and 311. Thus, there are a total of three electrodes for a single MEMS transducer in the microphone of FIG. 4, versus the four electrodes across two separate MEMS transducers required for the microphone of FIG. 2. Again, the microphone of FIG. 4 controls output sensitivity by varying the MEMS biasing as explained above with regard to FIG. 2. Particularly, the signal generated by the split electrodes 310 and 311 are modified by adjusting the bias voltages.

FIG. 5 illustrates a similar MEMS microphone to that of FIG. 4. However, the microphone of FIG. 5 includes a second split MEMS transducer 320 (“MEMS 2”), which replaces the speaker 100 and the acoustic volume 105 in a similar way as does the membrane 301 of FIG. 3. That is, the second split MEMS transducer 320 has split electrodes 322 and 323 (contained on the same die), which can generate acoustic pressure waves in the microphone packaging (i.e., an internal microphone volume). The acoustic pressure waves generated by the split electrodes 322 and 323 can be received by the first split MEMS transducer 312. Likewise, the first split MEMS transducer 312 can generate acoustic pressure waves to be received by the second split MEMS transducer 320. Thus, the first and second split MEMS transducers 312 and 320 can be calibrated in absence of the acoustic volume 105 and speaker 100. In particular, the first and second split MEMS transducers 312 and 320 can be calibrated according to the calibration procedures described in further detail below.

As with the electrodes 310 and 311 of the first split MEMS transducer 312, the signals generated by each of the electrodes 322 and 323 are sent to the switching block 116 and received by amplifiers 325 and 326. The signals are then sent to the summer 140. Further, the signals can be modified by adjusting the bias voltages applied to the electrodes 322 and 323. In particular, the controller 150 controls bias elements 328 and 329 to modify the bias voltages.

The absolute transducer sensitivity (such as for a pressure-sensitive membrane or MEMS transducer) refers to a characteristic of the transducer which cannot be readily altered by signal processing, alone. Reciprocity calibration can be used for calibrating the absolute transducer sensitivity of microphones. The technique exploits the reciprocal nature of certain transduction mechanisms. The reciprocity theorem states that if a voltage is supplied to a linear passive network at its first terminal, and produces a current at another terminal, the same voltage applied to a second terminal will generate the same amount of current as at the first terminal. Measurement microphones are usually capacitor microphones, and, thus, exhibit reciprocity behavior.

For the embodiments depicted in FIGS. 1, 2, and 4, reciprocity calibration is carried out using an acoustic coupler (i.e., the speaker 100 and the acoustic volume 105). The acoustic coupler outputs a pressure pulse into the test microphone and elicits the microphone's response. Provoking the microphone's response allows the microphone's sensitivity to be measured and thus calibrated. For the embodiment of FIG. 3, the function of the acoustic coupler is replaced by the third membrane 301. For the embodiment of FIG. 5, the function of the acoustic coupler is replaced by the second split MEMS transducer 320. However, it should be noted that the functions of the third membrane 301 and of the second split MEMS transducer 320 are not limited to those of an acoustic coupler, as described above. The membrane 301 and the MEMS transducer 320 can be used for other functions, as well, such as for transducing acoustic pressure waves. While the above discussion regarding FIGS. 1-5 are directed mainly toward adjusting the final output sensitivity of a microphone signal, the ensuing discussion is directed generally toward determining the absolute sensitivity of microphone transducers as well as calibrating the transducers.

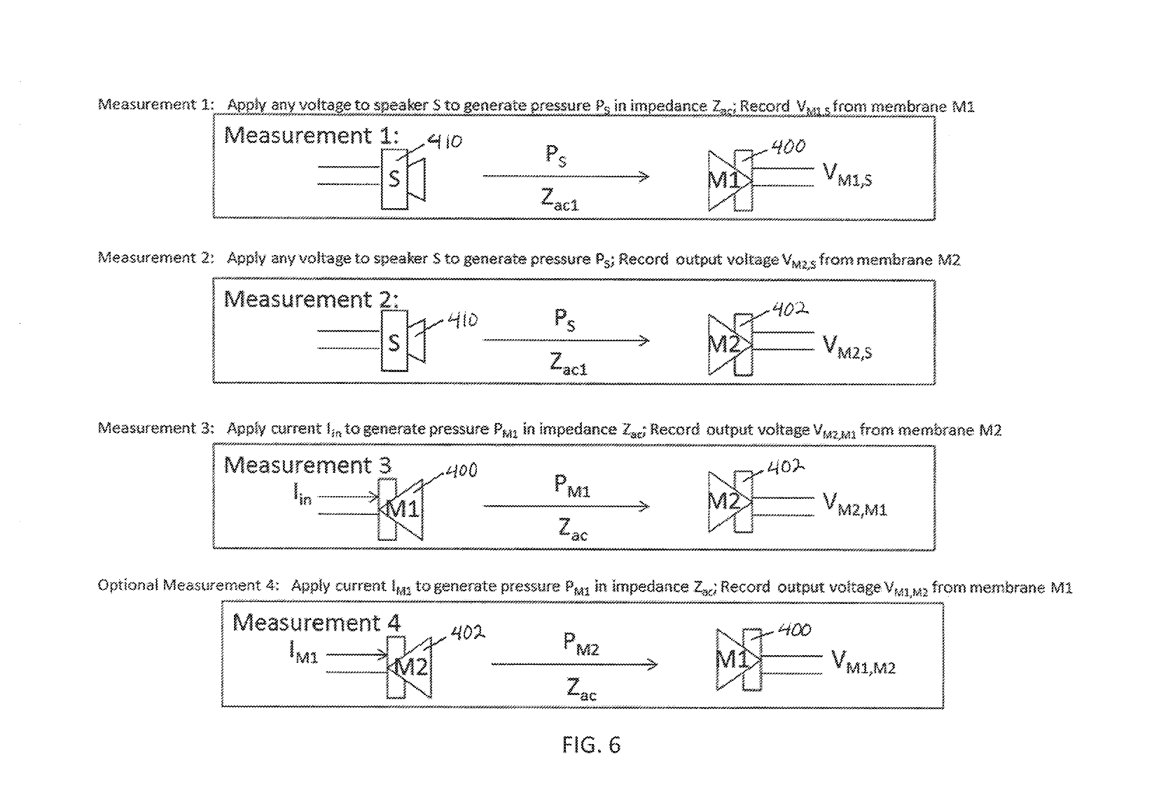

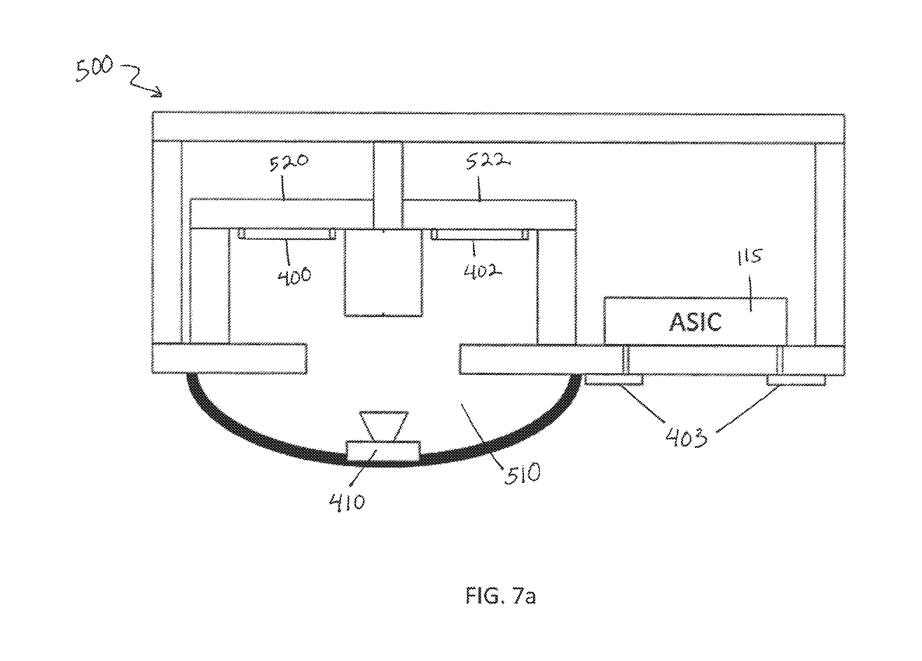

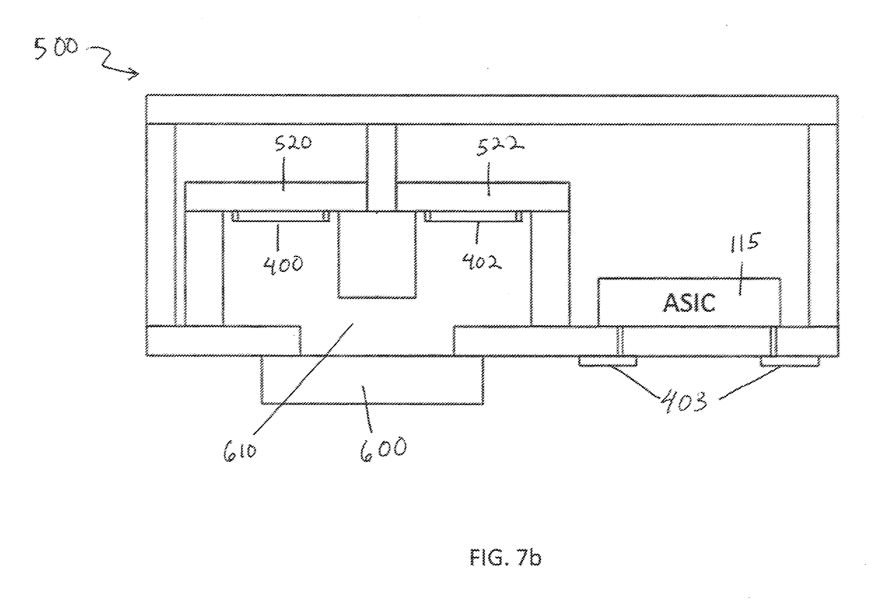

FIG. 6 shows an adaptation of the reciprocity technique for calibrating a microphone and the measurements taken to determine the absolute sensitivity of the microphone transducers. Specifically, four measurements are taken by the system to balance the sensitivities of the transducers. The microphone components involved in the calibration measurements are a first transducer 400 and a second transducer 402, as well as a speaker 410. However, note that the speaker 410 is not required to be an acoustic coupler like the speaker 100 and acoustic volume 105 of FIGS. 1, 2, and 4, but can also be an additional membrane or transducer such as the membrane 301 of FIG. 3 and the MEMS transducer 320 of FIG. 5. The transducers 400 and 402 can include any combination of the membranes 110, 111, and 301, the MEMS transducers 210 and 211, and/or the split-electrode MEMS transducers 312 and 320. FIG. 7A further illustrates a test setup 500 for Measurements 1 and 2. The test setup includes the transducers 400 and 402, the ASIC 115 with input/output ports 403, and an acoustic cavity 510 with an impedance Z_{ac1} (as shown in FIG. 6). The test setup 500 also includes a backplate 520 for the transducer 400, as well as a backplate 522 for the transducer 402. FIG. 7B illustrates the test setup 500 while performing Measurements 3 and 4 of FIG. 6. The changes in FIG. 7B include a sealing gasket 600 that replaces the speaker 410. The sealing gasket 600 forms a new acoustic cavity 610 with an impedance Z_{ac} (as shown in FIG. 6). For the embodiments of FIGS. 3 and 5, the sealing gasket 600 is not necessary, since the membranes and transducers of FIGS. 3 and 5, respectively, already share the volume of the microphone packaging, as will be described below in further detail.

Referring to FIG. 6, first and second pressure measurements are taken by applying a voltage to the speaker 410 (in Measurement 1 and Measurement 2). The external speaker voltage generates a pressure Pₛ in the acoustic cavity 510. The transducers 400 and 402 each transduce the pressure Ps and output a voltage. The voltage output by the trasducers 400 and 402 is then processed by the ASIC 115 (V_{M1,S} and V_{M2,S}). A third measurement (Measurement 3) is then taken for which the acoustic cavity 510 with attached speaker 410 is removed. The speaker 410 with acoustic cavity 510 is replaced with a sealing gasket 600, which forms the new acoustic cavity 610 with the impedance Z_{ac}. A current Iᵢₙ, is then supplied from the ASIC 115 to the transducer 400. The current Iᵢₙ generates a pressure P_{M1} in the acoustic cavity 610. The pressure P_{M1} is transduced by the transducer 402 and recorded as the output voltage V_{M2,M1}.

An optional fourth measurement may be taken by applying a current I_{M1} to the transducer 402. The current I_{M1} is the current generated by the voltage V_{M2,M1} generated in Measurement 3. When the current I_{M1} is applied to the transducer 402, the transducer 402 generates the pressure P_{M2} in the acoustic cavity 610. The pressure P_{M2} is then received by transducer 400 which then generates a voltage V_{M2, M1}.

The output voltages (V_{M1,S}, V_{M2,S}, V_{M1,M2}, and V_{M2,M1}) recorded by performing Measurements 1-4 are used to calculate the absolute sensitivity of the transducers 400 and 402 using the following calculations:

from Measurements 1 and 2,

V_{M2,S}=M_{o,M2}·Ps, V_{M1,}=M_{o,M1}·Ps (1, 2)

V_{M2,S}/V_{M1,S}=M_{o,M2}/M_{o,M1} (3)

M_{o,M2}=M_{o,M1}·(V_{M2,S}/V_{M1,S}) (4)

and then, further, from Measurement 3 and equation 4,

M_{o,M2}·M_{o,M1}=(1/Z_{ac})·(V_{M2,M1}/Iᵢₙ) (5)

(M_{o,M1})²·(V_{M2,S}/V_{M1,S})=(1/Z_{ac})·(V_{M2,M1}/Iᵢₙ). (6)

From Measurement 4, or, by substituting equation 6 into equation 3,

M_{o,M1}·M_{o,M2}=(1/Z_{ac})·(V_{M1,M2}/Iᵢₙ) (7)

(M_{o,M2})²·(V_{M1,S}/V_{M2,S})=(1/Z_{ac})·(V_{M1,M2}/Iᵢₙ). (8)

Under the assumption that the frequencies of interest (i.e., the frequencies of the pressure waves generated in the acoustic volume 610) are much lower than the requirement for lumped element acoustics to be valid, the acoustic impedance in the volume 610 can be expressed in terms of the following:

Z_{ac}=(r·c²)/(j·V·2ₚ·f) (9)

and the absolute sensitivity of the transducer 400 can be determined as,

(M_{o,m1})²=(V_{M1,S}/V_{M2,S})·(1/Z_{ac})·(V_{M2,M1})/(Iᵢₙ) (10)

and the absolute sensitivity of the transducer 402 can be determined as,

(M_{o,m2})²=(V_{M1,S}/V_{M2,S})·(1/Z_{ac})·(V_{M1,M2})/(Iᵢₙ) (11)

where:

V_{M2,S}=Voltage elicited in membrane (M2) by external speaker (S)

V_{M1,S}=Voltage elicited in membrane (M1) by external speaker (S)

V_{M1,M2}=Voltage elicited in membrane (M1) by membrane (M2)

V_{M2,M1}=Voltage elicited in membrane (M2) by external speaker (M1)

M_{o,M2}=Absolute sensitivity of membrane (M2)

M_{o,M1}=Absolute sensitivity of membrane (M1)

Pₛ=Pressure generated by external speaker S)

Z_{ac}=Impedance of common acoustic cavity

Iᵢₙ=Input voltage to transmitting speaker (either M1 or M2, depending on which other is receiving)

r=Gas density (e.g., the gas density for air)

c=Speed of sound

j=Imaginary operator, sqrt(−1)

2ₚf=Radian frequency of sound

V=Cavity volume.

The transducer sensitivity (i.e., M_{o,M1} and M_{o,M2}) is the ratio of the elicited voltage in the transducer by the speaker (V_{M1,S} or V_{M2,S}), to the acoustic pressure originally generated by the speaker (i.e., Pₛ). This concept is represented by equations 1 and 2. From this concept of the transducer sensitivity, the desired sensitivity (M_{o,M1} and M_{o,M2}) can be derived for use with the measured voltages (V_{M1,S}, V_{M2,S}, V_{M1,M2}, and V_{M2,M1}), as well as first-principle values, which are either known or easily measured.

Referring to FIG. 4, since the split electrodes 310 and 311 are mechanically identical and drive a split MEMS transducer, there are no longer two separate MEMS transducers (and thus no longer two separate electrodes to drive each transducer) sharing the acoustic volume 105. Therefore, the reciprocity measurements and calculations described above can be simplified, since, due to the split electrode arrangement (310 and 311), the single, split MEMS transducer can both produce and receive the pressure waves in Measurements 3 and 4, as previously described in reference to FIGS. 3 and 5. This reduces the impedance of the acoustic volume 105 to ±1 (Where “±1” corresponds to an in-phase capacitance change and “−1” corresponds to an out-of-phase capacitance change, which will be described below in further detail), since the pressure waves produced by the electrodes 310 and 311 do not travel across the acoustic volume 105. Instead, the force of the acoustic pressure waves generated by one electrode can directly influence (i.e. can be received directly by) the other electrode, since the electrodes share the same structure. In particular, this means that a first portion (i.e., electrode) of the split transducer (310) drives the production of acoustic pressure waves, while a second portion of the split transducer (311) receives the pressure waves via a second portion (i.e., electrode) of the split transducer. With Z_{ac} equal to ±1, the volume of the acoustic volume 105 does not need to be known, therefore simplifying. the reciprocity calculations described above.

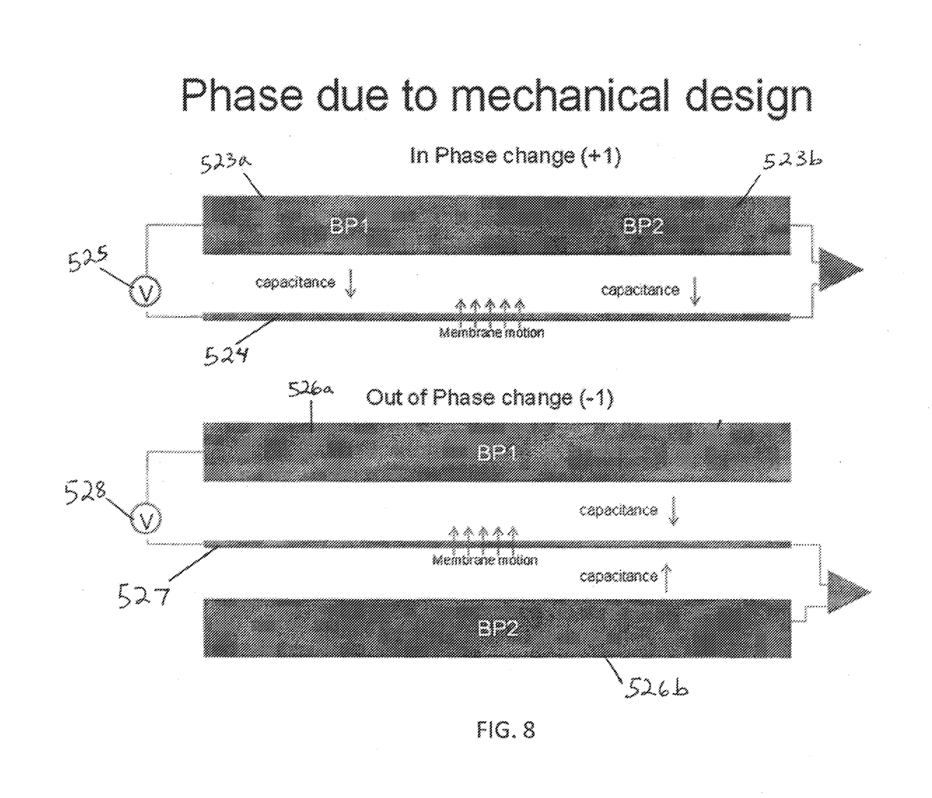

FIG. 8 illustrates two mechanical arrangements for an exemplary split MEMS transducer, and how each arrangement affects the change in capacitance sensed by the electrodes. The upper diagram (“In Phase Change (±1)”) shows a split MEMS transducer with electrodes 523a and 523b. The electrodes 523a and 523b are arranged on the same side of a moveable membrane 524. In this arrangement, if one electrode (e.g., the electrode 523a) generates acoustic pressure waves and causes the membrane 524 to displace, the other electrode (e.g., the electrode 523b) will sense the change in capacitance, arising from the membranes 524 displacement, in-phase with the pressure waves generated by the electrode 523a. This is due to each electrode being arranged on the same side of the membrane 524, such that the direction of displacement of the membrane 524 is “perceived” as the same by each electrode. However, the lower diagram (“Out of Phase change (−1)”) shows a split MEMS transducer with electrodes 526a and 526b, which are arranged on opposite sides of a membrane 527. In this arrangement, when the membrane 527 displaces, the direction of displacement observed by one electrode will be opposite the direction observed by the other. Thus, the change in capacitance sensed by one electrode (e.g., the electrode 526b) will be received out-of-phase with the pressure waves generated by the other (e.g., the electrode 526a).

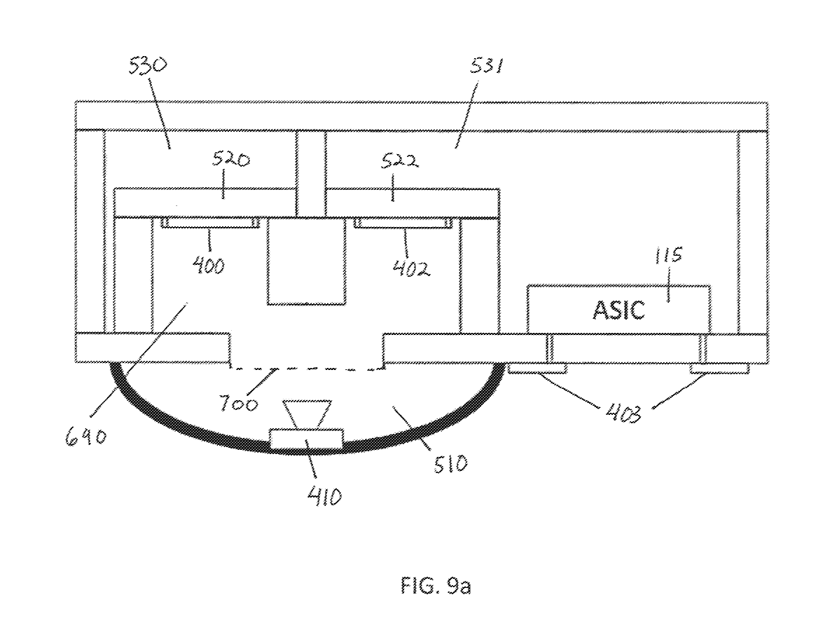

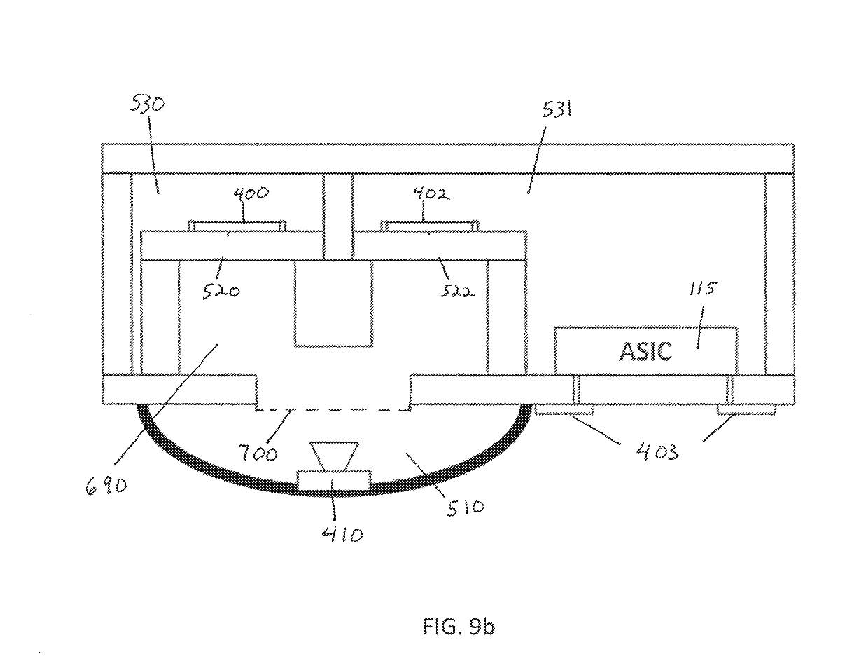

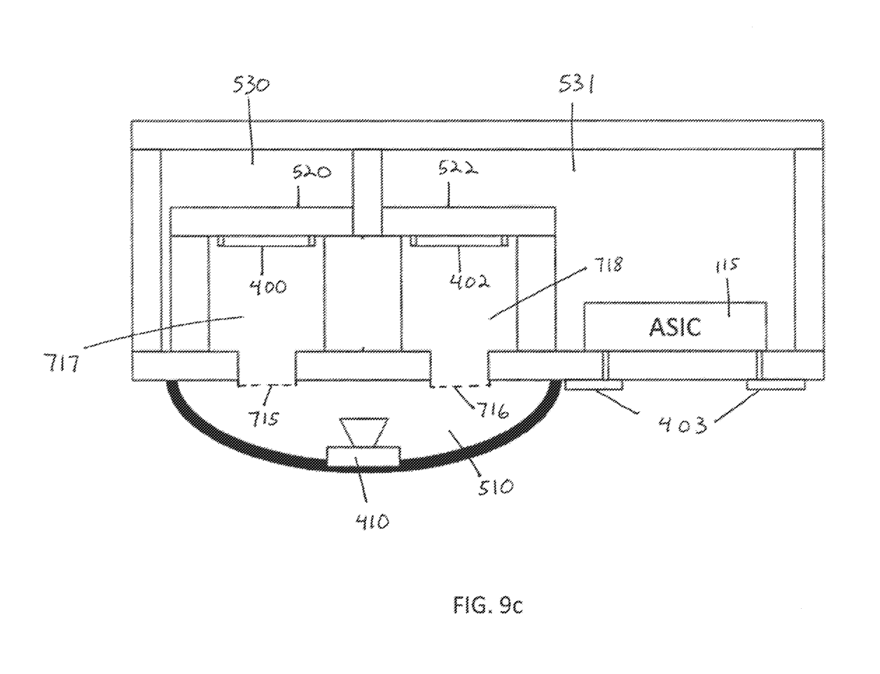

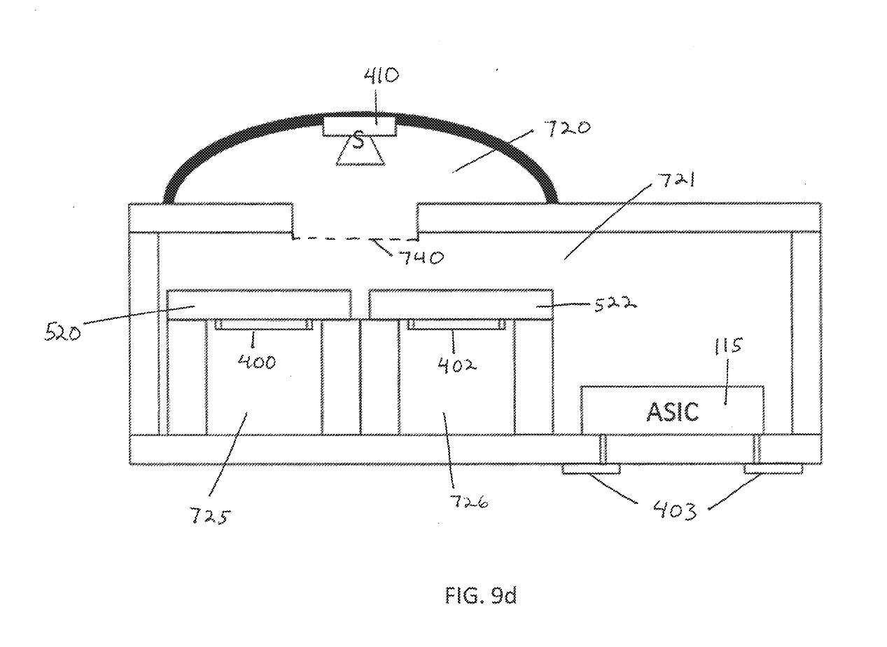

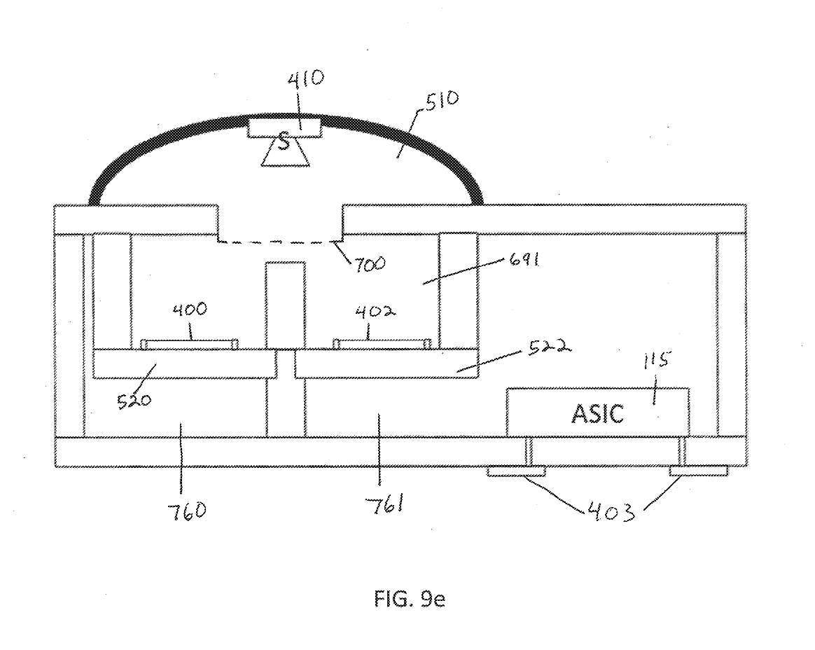

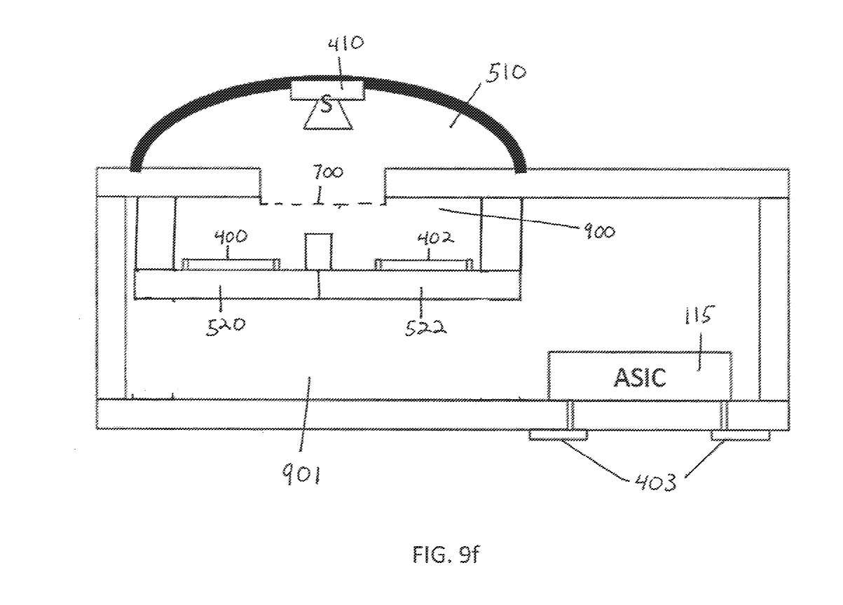

FIGS. 9A-9F illustrates alternative arrangements of exemplary test setups. Each exemplary arrangement includes the speaker 410, the transducers 400 and 402, the ASIC 115, and the ASIC input/output ports 403. FIG. 9A illustrates the same exemplary test arrangement as shown in FIG. 7A. FIG. 9B illustrates a similar test arrangement, however, the transducers 400 and 402 in FIG. 9B are affixed to the opposite side of the backplates 520 and 522, such that the transducer 400 is housed within the chamber 530 and the transducer 402 is housed within the chamber 531. FIG. 9C illustrates another exemplary test setup similar to FIGS. 9A and 9B, however, instead of haying one opening 700 (see FIGS. 9A and 9B) between the speaker 410 and the transducers 400 and 402, the arrangement of FIG. 9C exhibits two openings 715 and 716. The openings 715 and 716 create sub-chambers 717 and 718 that are contiguous with the volume 510, such that the transducer 400 is partially housed by the chamber 717 and the transducer 402 is partially housed by the transducer 718.

The test arrangement of FIG. 9D shows the speaker 410 positioned on the wall opposite the ASIC 115, such that the speaker 410 and the acoustic volume enclosing the speaker 410 are no longer along the same wall as the ASIC 115. The speaker 410 is enclosed. within the acoustic volume 720, which, unlike the volume 510 from FIGS. 9A-C forms a continuous space with the larger chamber 721. In FIG. 9D, the transducers 400 and 402 are housed within the enclosed chambers 725 and 726. Referring now to the exemplary test arrangement of FIG. 9E, the speaker 410 is still arranged similarly as in FIG. 9D, however, the speaker 410 is enclosed within the acoustic volume 510, as in FIGS. 9A-C. The arrangement of FIG. 9E is essentially the same as that of FIG. 9A, however, all the components of FIG. 9E (except for the ASIC 115 and the ASIC input/output ports 403) are “flipped” with respect to the arrangement of FIG. 9A. For example, the opening 700 is no longer contiguous with the wall having the ASIC 115, such that the sub-chambers 690 and 691 (housing the transducers 400 and 402) open away from the chambers 760 and 761 to the acoustic volume 510.

FIG. 9F shows a test arrangement similar to that of FIG. 9A. However, in FIG. 9F, the back volumes 530 and 531 of FIG. 9A are no longer separated. Instead, a single back volume 901 is formed. Further, the test arrangement of FIG. 9F has the speaker 410 positioned on the will opposite the ASIC 115, similar to the test arrangement of FIG. 9D.

Thus, embodiments of the invention provide, among other things, a microphone system that adjusts the final sensitivity of a microphone output signal by modulating the gains applied to an input signal, or by modulating the MEMS bias applied to MEMS transducers receiving the input signal. The invention includes a speaker, transducers, and an ASIC including a controller. The controller calculates, based on defined input received via an input/output interface, the amount of gain to apply to the input signals, or the amount of bias voltage to supply the MEMS transducers. The final output sensitivity and related parameters can be stored to a memory for future reference, and communicated with a user via the input/output interface (such as during a subsequent power on of the microphone). Further, it should be noted that the values of pressures and impedances described herein are subject to vary by application. Further, variations on the combination of first-principle parameters or measurements that are required prior to testing the microphone are possible. The disclosed microphone system encompasses the application of these variations.

Various features of the invention are set forth in the following claims.

What is claimed is:

1. A microphone system, the system comprising:
a first transducer outputting a first transducer signal;
a first bias circuit providing a first bias signal to the first transducer;
a second transducer outputting a second transducer signal;
a second bias circuit providing a second bias signal to the second transducer;
a first amplifier receiving the first transducer signal and outputting a first amplified transducer signal;
a second amplifier receiving the second transducer signal and outputting a second amplified transducer signal;
a summer receiving the first and second amplified transducer signals and outputting a summed signal;
a controller receiving the summed signal, the controller configured to
obtain a desired microphone output characteristic,
calculate a first adjustment amount and a second adjustment amount based on the desired microphone output characteristic,
modify a signal from the first transducer based on the first calculated adjustment amount,
modify a signal from the second transducer based on the second calculated adjustment amount, and,
output a microphone signal based on the summed signal.

2. The system of claim 1, wherein the first transducer and the second transducer are pressure-sensitive transducers.

3. The system of claim 2, wherein the first pressure-sensitive transducer and the second pressure-sensitive transducer share a die, such that a first portion of the die comprises the first pressure-sensitive transducer and a second portion of the die comprises the second pressure-sensitive transducer.

4. The system of claim 1, further including
a third transducer outputting a third transducer signal;
a third bias circuit providing a third bias signal to the third transducer; and
a third amplifier receiving the third transducer signal and outputting a third amplified transducer signal;
the summer, further configured to
receive the third amplified transducer signal, and
output the summed signal based on the first, second, and third amplified transducer signals; and,
the controller, thither configured to
calculate a third adjustment amount based on the desired microphone output characteristic, and
modify a signal from the third transducer based on the third calculated. adjustment amount.

5. The system of claim 4, further including
a fourth transducer outputting a fourth transducer signal;
a fourth bias circuit providing a fourth bias signal to the fourth transducer;
a fourth amplifier receiving the fourth transducer signal and outputting a fourth amplified transducer signal:
the summer, further configured to
receive the fourth amplified transducer signal, and
output the summed signal based on the first, second, third, and fourth amplified transducer signals; and,
the controller further configured to
calculate a fourth adjustment amount based on the desired microphone output Characteristic, and
modify a signal from the fourth transducer based on the fourth calculated adjustment amount.

6. The system of claim 5, wherein
the first pressure-sensitive MEMS transducer and the second pressure-sensitive MEMS transducer share a die, such that a first portion of the die comprises the first pressure-sensitive MEMS transducer and a second portion of the die comprises the second pressure-sensitive MEMS transducer, and
the third pressure-sensitive MEMS transducer and the second pressure-sensitive MEMS transducer share a second die, such that a first portion of the second die comprises the third pressure-sensitive MEMS transducer and a second portion of the second die comprises the fourth pressure-sensitive MEMS transducer.

7. The system of claim 1, wherein the desired microphone output characteristic is a desired sensitivity of the microphone.

5. The system of claim 1, wherein the controller modifies a gain of the first amplifier based on the first calculated adjustment amount and modifies a gain of the second amplifier based on the second calculated adjustment amount.

9. The system of claim 1, wherein the controller modifies the first bias signal based on the first calculated adjustment amount and modifies the second bias signal based on the second calculated adjustment amount.

10. The system of claim 1, further comprising, a memory, wherein at least one of the desired sensitivity, the first calculated adjustment amount, and the second calculated adjustment amount is stored in the memory.

11. The system of claim 1, further comprising an input/output interface, wherein the controller outputs the microphone signal via the input/output interface.

12. The system of claim 1, wherein the controller balances the first and second amplified transducer signals based on the first and second adjustment amounts.

13. A method of operating a microphone, comprising:
outputting a first transducer signal by a first transducer;
providing a first bias signal to the first transducer;
outputting a second transducer signal by a second transducer;
providing a second bias signal to the second transducer;
receiving the first transducer signal by a first amplifier and outputting a first amplified transducer signal by the first amplifier;
receiving the second transducer signal by a second amplifier and outputting a second amplified transducer signal by the second amplifier;
receiving the first and second amplified transducer signals by a summer, and outputting a summed signal by the summer;
receiving, by a controller, the summed signal;
obtaining, by the controller, a desired microphone output characteristic;
calculating, by the controller, a first adjustment amount and a second adjustment amount based on the desired microphone output characteristic;
modifying, by a controller, a signal from the first transducer based on the first calculated adjustment amount;
modifying, by the controller, a signal from the second transducer based on the second calculated adjustment amount; and,
outputting, by the controller, a microphone signal based on the summed signal.

14. The method of claim 13, wherein outputting the first and second transducer signals by the first and second transducers includes outputting the first transducer signal by a first pressure-sensitive transducer and outputting the second transducer signal by a second pressure-sensitive transducer.

15. The method of claim 14, wherein outputting the first and second transducer signals by the first and second transducers includes
outputting the first transducer signal by the first pressure-sensitive transducer, the first pressure-sensitive transducer comprising a first portion of a die, and
outputting the second transducer signal by the second pressure-sensitive transducer, the second pressure-sensitive transducer comprising a second portion of the die.

16. The method of claim 14, wherein obtaining the desired microphone output characteristic includes obtaining a desired sensitivity of the microphone.

17. The method of claim 14, wherein modifying the signal from the first and second transducers based on the first and second adjustment amounts includes
modifying a gain of the first amplifier based on the first calculated adjustment amount, and
modifying a gain of the second amplifier based on the second calculated adjustment amount.

18. The method of claim 14, wherein modifying the signal from the first and second transducers based on the first and second adjustment amounts includes
modifying the first bias signal based on the first adjustment amount, and
modifying the second bias signal based on the second adjustment amount.

19. The method of claim 14, further comprising storing at least one of the desired sensitivity, the first calculated adjustment amount, and the second calculated adjustment amount to a memory.

20. The method of claim 14, further comprising outputting, by the controller, the microphone signal via an input/output interface.

21. The method of claim 14, further comprising balancing, by the controller, the first and second amplified transducer signals based on the first and second adjustment amounts.
